(19) United States
(12) Patent Application Publication
(10) Pub. No.: US 2020/0349863 A1
(43) Pub. Date: Nov. 5, 2020

(54) EX VIVO LUNG SIMULATOR

(71) Applicant: XVIVO PERFUSION AB, Göteborg (SE)

(72) Inventor: Emur JENSEN, Denver, CO (US)

(21) Appl. No.: 16/755,014

(22) PCT Filed: Feb. 3, 2017
(86) PCT No.: PCT/EP2017/052325

§ 371 Date: Apr. 9, 2020

Related U.S. Application Data
(60) Provisional application No. 62/291,036, filed on Feb. 4, 2016.

(51) Int. Cl. G09B 23/28

(52) U.S. Cl. CPC G09B 23/285

(57) ABSTRACT

The present invention relates to methods and devices to simulate lung perfusion and or ventilation for training or development of lung related equipment.

### FIELD OF THE INVENTION

The present invention relates to products and methods for simulating isolated lung perfusion. These products and methods can be used for training on lung perfusion or for development of new lung perfusion devices.

### BACKGROUND TO THE INVENTION

Ex Vivo Lung Perfusion (EVLP) has become an accepted clinical procedure that can safely increase the number of available lungs for transplantation. The procedure involves pumping a perfusate through the vasculature of a lung with unknown function, outside the body, before the lung is selected or deselected for transplantation. Furthermore it involves ventilation of the lung. The circulation/ventilation circuit connected to the lung during EVLP is used to assess oxygenation capacity, pulmonary vascular resistance (PVR), and lung compliance etc. The Perfusate might be STEEN Solution (as described in WO2002/35929) or another solution appropriate for organ perfusion.

Although EVLP has become clinically accepted, the number of procedures is relatively few, less than 250 each year, spread out over about 30 clinics across the world. Most clinics that practise EVLP do fewer than 10 procedures annually. The low number of procedures causes an uncertainty and unfamiliarity of how to perform the procedure, which in turn further decreases the number of procedures performed. The result is patients dying waiting for lungs because they do not access the possibility of receiving lungs after EVLP. With more frequent training of the clinicians involved in EVLP a higher confidence level for the procedure occurs and more EVLP procedures will be performed.

Training on EVLP requires utilization of research/training lungs either of human or animal origin. Most often pig lungs are used, due to the anatomical similarities between human and pig lungs. However, both sources of lungs includes ethical considerations. It is desirable to find a way to improve the access of patients to lungs that have been through the EVLP procedure.

Lung simulators exists for training of in vivo use of ventilators. An example of an in vivo test lung is the Michigan lung from Michigan Instruments. These lung simulators do not circulate any perfusate fluid. Therefore oxygenation parameters, flow resistance and all other perfusate parameters important for an EVLP procedure cannot be monitored, hence they could not be used to train or develop an EVLP system.

### SUMMARY OF THE INVENTION

According to a first aspect, the present invention provides a lung simulator device, the device comprising an oxygenator, at least one inflatable reservoir, and tubing for ventilating and perfusing the device. The oxygenator is preferably a membrane oxygenator. There are preferably two inflatable air reservoirs and cannulation for perfusate flow through the device.

Accordingly the current invention comprises a lung simulator which is completely without material derived from animal origin, and which could be repeatedly used as a training lung. This non-animal derived development and training lung diminishes the ethical considerations concerned with using a human or animal lung and reduces costs per procedure, thereby allowing for more frequent training sessions, which in turn would increase the utilization of EVLP and therefore the number of lung transplantations, ultimately leading to better outcomes for patients.

In use, the lung simulator is perfused with a perfusate and ventilated by an external ventilator, as during a conventional EVLP with a human or animal derived lung. Furthermore, perfusate and ventilation parameters could be monitored, providing a real training experience, without sacrificing an animal or use of a human lung.

Furthermore, the device could be used during development of EVLP equipment or other lung devices.

According to a second aspect, the present invention relates to the use of a lung according to the first aspect of the invention, to train clinicians in the use of a lung related medical device or in the development of a lung related medical device.

According to a third aspect, the present invention relates to a method of simulating a lung, the method comprising the steps of: providing a lung simulator device according to the first aspect of the present invention; passing air into the device through the tubing to ventilate the inflatable reservoir and contact the oxygenator; and passing perfusate through the tubing to contact the oxygenator; wherein gas exchange occurs between the air and the perfusate in the oxygenator; and measuring one or more parameters of the perfusate and/or air.

### BRIEF DESCRIPTION OF THE DRAWINGS

FIG. 1 is a flow diagram of one preferred set-up of the lung simulator according to the present invention.

### DESCRIPTION

The utilization of animal or human lungs for EVLP training could be expensive and always involves ethical considerations. Human discarded lungs have the additional issue of availability when required. It is quite impossible to plan for a training session with a donated discarded human lung. Pig lungs are available upon planning, but killing an animal for training is ethically difficult and requires ethical permission at the institution. Furthermore, it is questionable to use lungs from animals on a device intended for human clinical use. Although all parts of the device that come in direct contact with the lung are disposable, there is still a theoretical risk involved with using a human device for animal procedures and this is often not in line with approved institutional procedures.

In contrast, the lung simulator of the present invention is always available, re-usable, inexpensive and without ethical considerations. This allow the surgeons, perfusionists and others involved in the procedure to train on the EVLP procedure at any convenient time and as often as is needed to build and maintain confidence in the knowledge of how to perform the procedure. Confidence in the ability of clinicians to perform a task increases their willingness to perform it and the burden of initiating a procedure is reduced once the confidence level of the clinician is sufficiently high.

One reason why many centers perform relatively few EVLP procedures, even though they have access to the EVLP technology, is lack of confidence in their ability to perform it. The fewer EVLPs that are being done, the higher is the hurdle to do an EVLP. As EVLP has been shown to increase the number of transplantations being performed at a clinic by at least 30%, the non-use of EVLP leads directly to missed opportunities for patients to receive lung transplants. Some of these patients will die waiting for lungs. Accordingly, regular training with the lung simulator of the present invention could avoid some of these deaths.

### Device Description for Ex-Vivo Lung Simulator

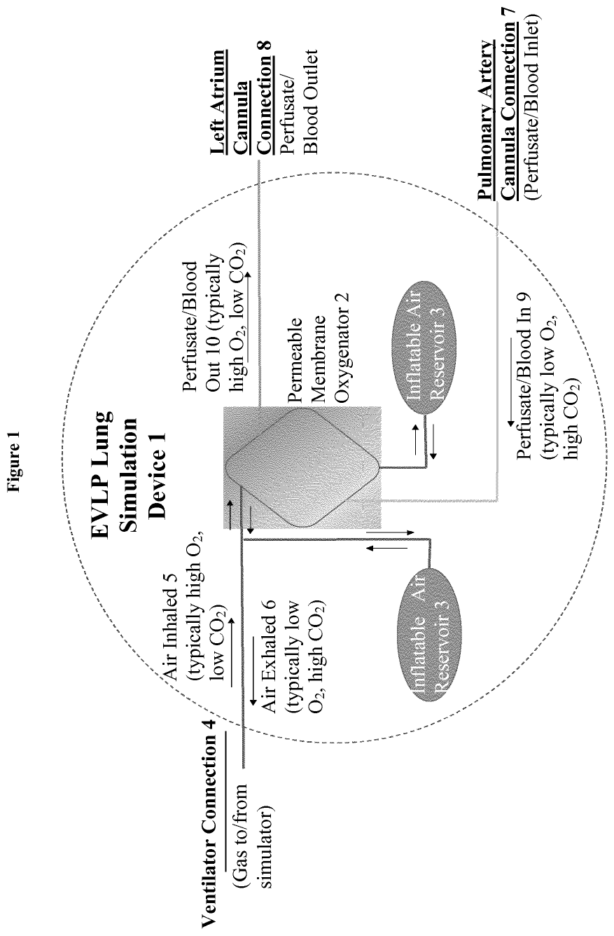

With reference to FIG. 1, the device 1 comprises a lung simulator which comprises an oxygenator 2, at least one inflatable reservoir 3, and tubing. It can therefore be constructed completely without material derived from animal origin, and is not dependent on use of a donated human or animal lung. The device of the present invention can be repeatedly used as a training lung. The lung simulator comprises an oxygenator, preferably a membrane oxygenator, at least one, preferably two, inflatable air reservoirs and cannulation for perfusate flow through the device.

The oxygenator 2 in the device of the present invention is preferably a permeable membrane oxygenator. An example of a suitable device is the Maquet Quadrox-i Hollow Fiber Oxygenator.

The lung simulator 1 includes at least one, and preferably two inflatable reservoirs 3. The inflatable air reservoir(s) 3 are used to collect, hold and exhale the ventilated air simulating airway resistance. Any suitable reservoirs can be used, such as Hamilton Medical 2.0 L Breathing Bag.

The lung simulator of the present invention also comprises tubing for ventilating and perfusing the device. An example of the flow paths is shown in FIG. 1. The tubing for ventilating the device 4 is typically connected to a ventilator (not shown) via a tracheal tube connector, which allows inspired and expired air to be analysed. The ventilation tubing 4 connects the ventilator with at least one of the inflatable reservoirs 3 via the oxygenator 2, so that air passes from the ventilator, through the oxygenator 2, and into the inflatable air reservoir 3 during the inspiratory cycle of the ventilator. Air is then held in the reservoir 3 before being passed out of the reservoir, and back though the oxygenator 2 during the expiatory cycle of the ventilator. FIG. 1 shows the ventilator connection with air inhaled 5 that typically has a high O2 and low CO2 going into the device, and air exhaled 6 which typically has a low O2 and high CO2 coming out of the device. The air goes directly in and out of one of the inflatable air reservoirs 3, and goes in and out of the other inflatable air reservoir 3 via the oxygenator 2.

The tubing for perfusing the device comprises an arterial inlet and a venous outlet connected to the oxygenator. As shown in FIG. 1, there is preferably a pulmonary artery cannula connection 7 for the perfusate or blood inlet (which is typically low 02 and high CO2 9) and a left atrium cannula connection 8 for the perfusate/blood outlet (that is typically high 02 and low CO2 10). The inlet and/or outlet is connected to an external pump (not shown) to pump the perfusate through the oxygenator 2.

In the oxygenator 2 the perfusate and air come into contact via a membrane (not shown) which allows gas exchange to occur. As shown in FIG. 1 this can be a permeable membrane oxygenator.

During use air is ventilated by an external ventilator connected to the lung simulator 1 via a normal tracheal tube connector 4 allowing ventilator parameters to be analysed. An arterial inlet 7 and a venous outlet 8 for the perfusate is connected to the membrane oxygenator 2, allowing perfusate parameters to be analysed.

This device is intended to be used as a lung simulator for ex-vivo lung perfusion systems. The device is designed to allow perfusate, blood, or mixture thereof to flow through the system as the device is ventilated via external ventilation system. Gas exchange between airway and perfusate is to occur as in a biological lung. Response parameters from both the perfusate and airway are intended to physiologically resemble that of a biological lung.

The device of the present invention preferably includes monitoring equipment (not shown) which can measure over time parameters of the perfusate and/or air before entering and/or after leaving the lung simulator device. In particular, the active and responding parameters that can be measured and monitored over time may comprises some or all of the following:

### Perfusate (Blood Path)

Flowrate
Pressure (pulmonary artery and left atrium)
Temperature (pulmonary artery and left atrium)
PVR (Pulmonary Vascular Restriction)
Blood gas concentrations (pulmonary artery and left atrium)

### Airway

Tidal Volume
Peak Pressure
PEEP (positive end-expiatory pressure)
Breathing Rate (Breaths per Minute)
Inspiratory to Expiratory Ratio
Oxygen Concentration
Compliance

### Uses

The device is intended to be used for training medical staff on EVLP procedures with EVLP systems. The EVLP system comprises for example the XPS™ from XVIVO Perfusion, the LS1 and LS2 system from Vivo line and the OCS from Transmedics, or any other commercial or home-made system can be used.

The simulator lung can also be used as a development tool for designing and optimizing EVLP systems or other medical devices to be used on lung(s) and as a demonstration and academic tool for ex vivo surgical lung procedures.

The simulator lung could be used with perfusates used in clinical EVLP such as STEEN Solution™, available from XVIVO Perfusion AB, but it could also be used with any other solution. For example the simulator lung could be perfused with water. This is an additional advantage as use of water or other cheaper solutions reduces the cost of the training procedure even more.

### Method of Operation

Perfusate is pumped through the lung simulator via external pumping equipment.

Air is delivered into the lung simulator during the inspiratory cycle of respiratory ventilator. Air is pushed back from the lung simulator to ventilator during the expiatory cycle of ventilator.

Gas exchange occurs inside the lung simulator via permeable membrane.

Instrumentation external to simulator is used to measure EVLP parameters.

### Example

A test run was performed using the lung simulator device with the XPS™ system. Water was used as the perfusate. The EVLP cycle was run according to standard protocol for the XPS™. The EVLP cycle lasted for five hours.

The following parameters were set on the EVLP equipment ventilator and perfusing pump.

| | | | | | |
|---|---|---|---|---|---|
| EVLP time (min) | 60 | 120 | 180 | 240 | 300 |
| Breathing | 10 | 10 | 10 | 10 | 10 |
| frequency/min | | | | | |
| PEEP (cmH2O) | 5 | 5 | 5 | 5 | 5 |
| Peak airway pressure | 25 | 25 | 25 | 25 | 25 |
| (cmH2O) | | | | | |
| FiO2 (%) | 100 | 100 | 100 | 100 | 100 |
| Flow (L/min) | 2.0 | 2.0 | 2.0 | 2.0 | 2.0 |

The following parameters were continuously monitored and registered every hour.

Left Atrium Pressure (LA-P mmHg), Left Atrium pH (LA-pH), Left Atrium PO2 (LA-PO2 mmHg), Left Atrium temperature (LA-T ° C.), Pulmonary Artery Pressure (PA-P mmHg), Pulmonary Artery pH (PA-pH), Pulmonary Artery PO2 (PA-PO2 mmHg), Pulmonary Artery Temperature (PA-T ° C.), Dynamic compliance (cdyn ml/cmH2O) and Pulmonary Vascular Resistance (PVR mmHg×min/L).

| | | | | | |
|---|---|---|---|---|---|
| EVLP time (min) | 60 | 120 | 180 | 240 | 300 |
| LA-P (mmHg) | 9 | 3 | 4 | 3 | 3 |
| LA-pH | Not | Not | Not | 7.23 | 7.24 |
| | calibrated | calibrated | calibrated | | |
| LA-PO2 (mmHg) | 219 | 353 | 464 | 450 | 457 |
| LA-T (° C.) | 37.0 | 36.9 | 37.0 | 37.0 | 36.8 |
| PA-P (mmHg) | 21 | 14 | 15 | 15 | 15 |
| PA-pH | Not | Not | Not | 7.02 | 7.00 |
| | calibrated | calibrated | calibrated | | |
| PA-PO2 (mmHg) | 49 | 77 | 138 | 114 | 114 |
| PA-T (° C.) | 38.0 | 38.0 | 38.0 | 38.0 | 38.0 |
| cdyn (ml/cmH2O) | 46.3 | 31.9 | 30.2 | 31.4 | 29.9 |
| PVR (mmHg × | 436 | 440 | 440 | 473 | 473 |
| min/L) | | | | | |

1. A lung simulator device, the device comprising an oxygenator, at least one inflatable reservoir, and tubing for ventilating and perfusing the device.

2. The device according to claim 1, wherein the device is connected to an external pump, a ventilator and monitoring equipment.

3. The device according to claim 2, wherein the device comprises EVLP equipment.

4. The device according to claim 1, wherein the device has two inflatable reservoirs.

5. The device according to claim 1, wherein the oxygenator is a permeable membrane oxygenator.

6. The device according to claim 1, wherein the tubing for perfusing the device comprises an arterial inlet and a venous outlet connected to the oxygenator.

7. The device according to claim 1, wherein the tubing for ventilating the device is connected from a ventilator to at least one inflatable reservoir via the oxygenator.

8. (canceled)

9. A method of simulating a lung, the method comprising the steps of:
providing a lung simulator device, the device comprising an oxygenator, at least one inflatable reservoir, and tubing for ventilating and perfusing the device;
passing air into the device through the tubing to ventilate the inflatable reservoir and contact the oxygenator;
passing perfusate through the tubing to contact the oxygenator, wherein gas exchange occurs between the air and the perfusate in the oxygenator; and
measuring one or more parameters of the perfusate and/or air.
